(19) United States
(12) Patent Application Publication
(10) Pub. No.: US 2024/0376650 A1
(43) Pub. Date: Nov. 14, 2024

(54) PROCESS FOR BONDING AND HEAT SETTING NONWOVEN WEBS

(71) Applicant: Berry Global, Inc., Evansville, IN (US)

(72) Inventors: Ralph A. Moody, III, Mooresville, NC (US); Mehmet Selcuk Sinangil, Mooresville, NC (US); Abhay Joijode, Huntersville, NJ (US); Jerry Snider, Mooresville, NC (US); Saravanan Andan, Mount Juliet, TN (US)

(21) Appl. No.: 18/660,965

(22) Filed: May 10, 2024

Related U.S. Application Data
(60) Provisional application No. 63/466,032, filed on May 12, 2023.

(51) Int. Cl. D04H 1/56; D04H 1/4382; D04H 1/541

(52) U.S. Cl. CPC D04H 1/56; D04H 1/43825; D04H 1/43835; D04H 1/5418

(57) ABSTRACT

A process for forming a nonwoven fabric is provided. The process includes depositing at least a first nonwoven layer comprising a first plurality of interlaid individual meltspun fibers, which may comprise a plurality of monocomponent fibers having different onset of melting temperatures, bicomponent fibers having distinct fiber components having different onset of melting temperatures, and/or a plurality of different bicomponent fibers having one or more distinct components having different onset of melting temperatures, directly or indirectly onto a moving collection belt to form a precursor nonwoven. The process includes subjecting the precursor nonwoven web to a heat-setting operation (HSO) to heat-set the first plurality of interlaid individual meltspun fibers to form an intermediate nonwoven fabric, followed by consolidating the intermediate nonwoven fabric to provide that nonwoven fabric.

### CROSS-REFERENCE TO RELATED APPLICATIONS

This application claims priority under 35 U.S.C. § 119 to U.S. patent application No. 63/466,032 filed May 12, 2023, which is expressly incorporated by reference herein in its entirety.

### TECHNICAL FIELD

Embodiments of the presently-disclosed invention relate generally to processes for forming nonwoven fabrics, in which the processes include subjecting a nonwoven web to a heat-setting operation while the nonwoven web is physically restrained to mitigate or prevent shrinkage or relative movement between individual meltspun fibers to “heat set” the nonwoven web, followed by consolidation to form a nonwoven fabric.

### BACKGROUND

In nonwoven fabrics, bicomponent fibers may be used in which a component of the bicomponent fibers, such as a sheath component of a bicomponent fibers having a sheath/core configuration, may be formed from a lower melting point polymeric composition while the other component is formed from a different polymeric composition that has a higher melting point. In this regards, the component of the bicomponent fibers formed from the lower melting point polymeric composition may be used for consolidation while maintaining the structural integrity of the component of the bicomponent fibers formed from the polymeric composition having the higher melting point. Alternatively, nonwoven fabrics may be formed from a mixture of fibers formed from different polymeric materials, such as a first group of fibers formed from a lower melting point polymeric composition and a second group of fibers formed from a higher melting point polymeric composition. Each of these approaches, however, requires the use of multiple polymeric compositions as well as multiple polymer flow pathways from respective polymer sources to respective spinneret capillaries.

Alternately, as described in co-owned and co-pending application 63/427,584 filed on Nov. 23, 2022, which was converted to co-owned and co-pending application Ser. No. 18/514,141 filed on Nov. 20, 2023, a method is disclosed that utilizes particular spinnerets for melt spinning a polymeric composition (e.g., a single polymeric composition) to provide nonwoven fabrics that include lower melting point fibers, and higher melting point fibers that may optionally remain in a solidified state during consolidation.

### SUMMARY OF INVENTION

One or more embodiments of the invention may address one or more of the aforementioned problems. Certain embodiments according to the invention provide a process for forming a nonwoven fabric including a step of depositing at least a first nonwoven layer comprising a first plurality of interlaid individual meltspun fibers directly or indirectly onto a moving collection belt to provide a precursor nonwoven web having an average initial cross-direction (CD) width and/or an average initial basis weight. The first plurality of interlaid individual meltspun fibers may comprise (a) a combination of a first group of monocomponent fibers having a first onset of melting temperature and a second group of monocomponent fibers having a second onset of melting temperature that is lower than the first onset of melting temperature, (b) bicomponent fibers including a first component having a first onset of melting temperature and a second component having a second onset of melting temperature that is lower than the first onset of melting temperature, (c) a combination of a first group of bicomponent fibers having a first higher melting point component and a first lower melting point component, and a second group of bicomponent fibers having a second higher melting point component and a second lower melting point component that begins melting prior to the first lower melting point component; or (d) any combination of (a)-(c). The process may also comprise conveying the precursor nonwoven web through a heat-setting operation (HSO) comprising (a) restraining the precursor nonwoven web directly or indirectly within a heat-setting nip defined between the moving collection belt and a portion of a counter surface, such as a portion of a heat-setting apparatus, to mitigate relative movement of individual meltspun fibers during the HSO, and (b) subjecting the precursor nonwoven web to an elevated temperature sufficient to increase a tackiness of the second group of monocomponent fibers and/or the second component of bicomponent fibers having the second onset of melting temperature to provide an intermediate nonwoven fabric and/or the second lower melting point component of the second group of bicomponent fibers. The process may also comprise removing the intermediate nonwoven fabric from the HSO, wherein the intermediate nonwoven fabric has an average post-heat-setting CD width and/or an average post-heat-setting basis weight, and consolidating the intermediate nonwoven fabric to provide that nonwoven fabric having an average final CD width and/or an average final basis weight. In accordance with certain embodiments of the invention, the HSO may lightly bond or consolidate a portion of the meltspun fiber together to provide sufficient integrity for handling while the consolidation step more thoroughly bonds the meltspun fibers together to provide a significantly more durable and strong final nonwoven fabric relative to the intermediate nonwoven fabric formed after the HSO.

In another aspect, the present invention provides a heat-set nonwoven fabric including at least a first plurality of interlaid individual meltspun fibers comprising (a) a combination of a first group of monocomponent fibers having a first onset of melting temperature and a second group of monocomponent fibers having a second onset of melting temperature that is lower than the first onset of melting temperature, (b) bicomponent fibers including a first component having a first onset of melting temperature and a second component having a second onset of melting temperature that is lower than the first onset of melting temperature, (c) a combination of a first group of bicomponent fibers having a first higher melting point component and a first lower melting point component, and a second group of bicomponent fibers having a second higher melting point component and a second lower melting point component that begins melting prior to the first lower melting point component; or (d) any combination of (a)-(c). The nonwoven fabric may be a through-air-bonded nonwoven fabric, chemically bonded nonwoven fabric, mechanically consolidated nonwoven fabric, and/or a thermally bonded nonwoven fabric. In this regard, nonwoven webs (e.g., spunbond webs) may be consolidated via a through-fluid-bonding (e.g., fluid includes hot air or steam) process in which, optionally, only the lower melting point fibers (or component) are softened, melted, and/or flowed throughout a portion of the nonwoven web to form bonds with the higher melting point fibers. In this regard, the structural integrity of the resulting nonwoven fabric, in accordance with certain embodiments of the invention, may be provided by the higher melting point fibers (or higher melting point fiber components) that may remain in a non-deformed or substantially non-deformed (e.g., the cross-section of the high melting point fibers or fiber components remain the same or substantially the same before, during, and after the consolidation operation). To the contrary, the lower melting point fibers (or fiber components) may have a deformed cross-section or individually undiscernible as individual fibers due to melting and/or flowing to provide the bonding mechanism for consolidation. For example, the lower melting point fibers (or fiber components) may at least partially melt and flow through at least some of the gaps defined between the higher melting point fibers. As the lower point melting fibers (or fiber components) flow through gaps between the higher melting point fibers, the deforming and flowing lower melting point fibers (e.g., less crystalline or amorphous) coat the surfaces of the higher melting point fibers (or fiber components). Upon solidification of the lower melting point material (e.g., the melted and flowed lower melting point fibers) after coating the surfaces of the higher melting point fibers (or fiber components), the lower melting point material forms bonds to and between the higher melting point material (e.g., the deformed lower melting point fibers).

In another aspect, the present invention provides a method of forming a composite comprising forming or providing a nonwoven fabric, such as those described and disclosed herein, and bonding a film layer to the nonwoven fabric. In another aspect, the present invention provides a composite including a nonwoven fabric, such as those described and disclosed herein, and a film.

### BRIEF DESCRIPTION OF THE DRAWING(S)

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout, and wherein:

FIG. 1 illustrates a schematic of a general process in accordance with certain embodiments of the invention;

FIG. 2 illustrates a schematic of another general process in accordance with certain embodiments of the invention;

FIG. 3 illustrates a schematic of another general process in accordance with certain embodiments of the invention;

FIG. 4 illustrates a schematic of another general process in accordance with certain embodiments of the invention;

FIG. 5 illustrates a nonwoven fabric including a first group of meltspun fibers (e.g., first group of monocomponent meltspun fibers and/or a first group of bicomponent fibers) and a second group of meltspun fibers (e.g., second group of monocomponent meltspun fibers and/or a second group of bicomponent fibers) in accordance with certain embodiments of the invention;

FIG. 6 illustrates a nonwoven fabric including a first group of meltspun fibers (e.g., first group of monocomponent meltspun fibers and/or a first group of bicomponent fibers) defining two high melting point regions and a second group of meltspun fibers (e.g., second group of monocomponent meltspun fibers and/or a second group of bicomponent fibers) defining a low melting point region in accordance with certain embodiments of the invention;

FIG. 7 illustrates a nonwoven fabric including a first group of meltspun fibers (e.g., first group of monocomponent meltspun fibers and/or a first group of bicomponent fibers) defining an interior high melting point region and a second group of meltspun fibers (e.g., second group of monocomponent meltspun fibers and/or a second group of bicomponent fibers) defining two low melting point region in accordance with certain embodiments of the invention;

FIG. 8 illustrates a nonwoven fabric including a first group of meltspun fibers (e.g., first group of monocomponent meltspun fibers and/or a first group of bicomponent fibers) defining a plurality of high melting point regions and a second group of meltspun fibers (e.g., second group of monocomponent meltspun fibers and/or a second group of bicomponent fibers) defining a plurality of low melting point regions, in which the high melting point regions and the low melting point regions are located in alternating fashion in a z-direction, in accordance with certain embodiments of the invention;

FIG. 9 illustrates another nonwoven fabric including a first group of meltspun fibers (e.g., first group of monocomponent meltspun fibers and/or a first group of bicomponent fibers) defining a plurality of high melting point regions and a second group of meltspun fibers (e.g., second group of monocomponent meltspun fibers and/or a second group of bicomponent fibers) defining a plurality of low melting point regions, in which the high melting point regions and the low melting point regions are located in alternating fashion in a z-direction, in accordance with certain embodiments of the invention;

FIG. 10 illustrates a nonwoven fabric including a first group of meltspun fibers (e.g., first group of monocomponent meltspun fibers and/or a first group of bicomponent fibers) defining a plurality of high melting point regions and a second group of meltspun fibers (e.g., second group of monocomponent meltspun fibers and/or a second group of bicomponent fibers) defining a plurality of low melting point regions, in which the high melting point regions and the low melting point regions are located in alternating fashion in the cross-direction, in accordance with certain embodiments of the invention;

FIG. 11 illustrates a nonwoven fabric including a first group of meltspun fibers (e.g., first group of monocomponent meltspun fibers and/or a first group of bicomponent fibers) defining a plurality of high melting point regions and a second group of meltspun fibers (e.g., second group of monocomponent meltspun fibers and/or a second group of bicomponent fibers) defining a plurality of low melting point regions, in which the high melting point regions and the low melting point regions are located in alternating fashion in both the z-direction and the cross-direction, in accordance with certain embodiments of the invention;

FIG. 12 illustrates a nonwoven fabric having a second group of meltspun fibers (e.g., second group of monocomponent meltspun fibers and/or a second group of bicomponent fibers) defining continuous low melting point region and a first group of meltspun fibers (e.g., first group of monocomponent meltspun fibers and/or a first group of bicomponent fibers) defining a plurality of high melting point regions dispersed throughout the low melting point region in accordance with certain embodiments of the invention; and

FIG. 13 illustrates a nonwoven fabric having a first group of meltspun fibers (e.g., first group of monocomponent meltspun fibers and/or a first group of bicomponent fibers) defining continuous high melting point region and a second group of meltspun fibers (e.g., second group of monocomponent meltspun fibers and/or a second group of bicomponent fibers) defining a plurality of low melting point regions dispersed throughout the high melting point region in accordance with certain embodiments of the invention.

### DETAILED DESCRIPTION

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The presently-disclosed invention relates generally to processes for forming a nonwoven fabric that has been subjected to a heat-setting operation (HSO). The nonwoven web may comprise a plurality of individual meltspun fibers, such as different groups of monocomponent fibers having different onset of melting temperatures, bicomponent fibers having a high melting point component and a low melting point component, different groups of bicomponent fibers each having respective high melting point and low melting point components, directly or indirectly collected onto a moving collection belt. The nonwoven web may then be subjected to the HSO that comprises subjecting the nonwoven web to an elevated temperature to at least increase the tackiness of the lowest melting point material present in the nonwoven web while the nonwoven web remains under sufficient compaction or restraint to reduce heat shrinkage during subsequent consolidation. The HSO may include, for example, the use of thermally heated press rolls or hot air knives to increase the tackiness of the lowest melting point material in the nonwoven web. The HSO beneficially “heat sets” the higher melting point materials to reduce shrinkage during heating cycles that maintains web widths and additional shrinkage in a later bonding cycles like calendering, ultrasonic, chemical, or through-air-bonding. The HSO may accomplish this benefit by modifying the path of the collection belt using, for example, a porous drum, allowing transportation of the collected web (prior to any heat application) and the web path minimally wrapping the drum, for example, 180-340°, preferably around 270°. In this manner the unconsolidated nonwoven web laydown remains undisturbed. The nonwoven web (fleece) is trapped between the laydown belt (e.g., collection belt) and the drum, where it is then heated (annealed) to achieve heat setting of the higher melt temperature polymer. Additionally, the HSO may further include a cooling portion or step, in which a smaller radial length that cools the nonwoven web before exiting the ‘nip” formed by the belt to drum contact. Such an approach, in accordance with certain embodiments of the invention, provides the nonwoven web integrity by softening/melting of the lower melt polymer fibers (or fiber components) providing pre-bonding for further unsupported transport to the final bonding unit. The final consolidation or bonding unit may include, for example, through-air-drum bonding, thermal calendering, ultrasonic bonding, or chemical bonding. In accordance with certain embodiments of the invention, the process provides undisturbed nonwoven web formation, by slightly bonding under slight compression of the nonwoven web while also allowing a heat setting process to avoid shrinkage of any mix of fibers with high glass transition temperatures. In accordance with certain embodiments of the invention, the fiber construction of different melt points can be created via bicomponent fibers, or a blend of monocomponent fibers having different melt points created through a bicomponent extrusion, but also via a plurality of monocomponent or bicomponent fibers with different processing conditions as described above related to meltspinning dies disclosed in application 63/427,584 filed on Nov. 23, 2022, which was converted to application Ser. No. 18/514,141 filed on Nov. 20, 2023, the entire contents of each are hereby incorporated by reference, to create fibers with different melting temperatures from a single die and/or single polymeric composition.

In this regard, the fibers extruded from the respective capillaries, such as from meltspinning dies disclosed in application 63/427,584, which was converted to application Ser. No. 18/514,141 filed on Nov. 20, 2023, can define corresponding respective zones or regions thereof may provide a resulting nonwoven web having fibers formed from a polymeric material and having a range of fibers with differing melting points and/or melting ranges, which may be distinct and/or unique (e.g., non-overlapping melting ranges) and/or have overlapping melting point ranges. By way of example only, a single spinneret may include a first zone of orifices a second zone of orifices. Accordingly, fibers formed or extruded from one zone will have the most crystalline nature or degree and exhibit the highest melting point, while fibers formed or extruded from the other zone will have the least crystalline nature or degree (e.g., amorphous) and exhibit the lowest melting point. In this regard, the resulting nonwoven web (e.g., spunbond web) will be composed of at least 2 separate groups of fibers as determined by degree of crystallinity and/or melting point or melting range. Such a formed nonwoven web, therefore, could be initially heat treated (e.g., annealed, lightly consolidated) to a temperature sufficient to melt the fibers formed from the second zone of capillaries (e.g., fibers with the lowest melting point) and lightly consolidate that nonwoven web to impart sufficient durability for subsequent processing (e.g., conveyance, mating with other materials, such as films, nonwovens, etc.). A final consolidation step may subsequently be performed by heating the fibers to a temperature that melts the fibers more fully, to provide a more robust level of consolidation,

The terms “substantial” or “substantially” may encompass the whole amount as specified, according to certain embodiments of the invention, or largely but not the whole amount specified (e.g., 95%, 96%, 97%, 98%, or 99% of the whole amount specified) according to other embodiments of the invention.

The terms “polymer” or “polymeric”, as used interchangeably herein, may comprise homopolymers, copolymers, such as, for example, block, graft, random, and alternating copolymers, terpolymers, etc., and blends and modifications thereof. Furthermore, unless otherwise specifically limited, the term “polymer” or “polymeric” shall include all possible structural isomers; stereoisomers including, without limitation, geometric isomers, optical isomers or enantiomers; and/or any chiral molecular configuration of such polymer or polymeric material. These configurations include, but are not limited to, isotactic, syndiotactic, and atactic configurations of such polymer or polymeric material. The term “polymer” or “polymeric” shall also include polymers made from various catalyst systems including, without limitation, the Ziegler-Natta catalyst system and the metallocene/single-site catalyst system. The term “polymer” or “polymeric” shall also include, in according to certain embodiments of the invention, polymers produced by fermentation process or biosourced.

The terms “nonwoven” and “nonwoven web”, as used herein, may comprise a web having a structure of individual fibers, fibers, and/or threads that are interlaid but not in an identifiable repeating manner as in a knitted or woven fabric. Nonwoven fabrics or webs, according to certain embodiments of the invention, may be formed by any process conventionally known in the art such as, for example, meltblowing processes, spunbonding processes, needle-punching, hydroentangling, air-laid, and bonded carded web processes. A “nonwoven web”, as used herein, may comprise a plurality of individual fibers that have not been subjected to a consolidating process. In certain instances, the “nonwoven web” may comprises a plurality of layers, such as one or more spunbond layers and/or one or more meltblown layers. For instance, a “nonwoven web” may comprises a spunbond-meltblown-spunbond structure.

The terms “fabric” and “nonwoven fabric”, as used herein, may comprise a web of fibers in which a plurality of the fibers are mechanically entangled or interconnected, fused together, and/or chemically bonded together. For example, a nonwoven web of individually laid fibers may be subjected to a bonding or consolidation process to bond at least a portion of the individually fibers together to form a coherent (e.g., united) web of interconnected fibers.

The term “consolidated” and “consolidation”, as used herein, may comprise the bringing together of at least a portion of the fibers of a nonwoven web into closer proximity or attachment there-between (e.g., thermally fused together, chemically bonded together, and/or mechanically entangled together) to form a bonding site, or bonding sites, which function to increase the resistance to external forces (e.g., abrasion and tensile forces), as compared to the unconsolidated web. The bonding site or bonding sites, for example, may comprise a discrete or localized region of the web material that has been softened or melted and optionally subsequently or simultaneously compressed to form a discrete or localized deformation in the web material. Furthermore, the term “consolidated” may comprise an entire nonwoven web that has been processed such that at least a portion of the fibers are brought into closer proximity or attachment there-between (e.g., thermally fused together, chemically bonded together, and/or mechanically entangled together), such as by thermal bonding or mechanical entanglement (e.g., hydroentanglement) as merely a few examples. Furthermore, the term “consolidated” and “consolidation” may comprise the bonding by means of a through-air-bonding operation. The term “through-air bonded” and “though-air-bonding”, as used herein, may comprise a nonwoven web consolidated by a bonding process in which hot air is used to fuse the fibers at the surface of the web and optionally internally within the web. By way of example only, hot air can either be blown through the web in a conveyorized oven or sucked through the web as it passes over a porous drum as a vacuum is developed. The temperature of and the rate of hot air are parameters that may determine the level or the extent of bonding in nonwoven web. In accordance with certain embodiments of the invention, the temperature of the hot air may be high enough to melt, induce flowing, and/or fuse the a plurality of fibers having a lower melting point temperature or onset of lower melting point temperature (e.g., amorphous fibers) to a plurality of fibers having a higher melting point temperature or onset of lower melting point temperature (e.g., semi-crystalline or crystalline fibers). Such a web may be considered a “consolidated nonwoven”, “nonwoven fabric” or simply as a “fabric” according to certain embodiments of the invention.

As used herein, “meltspun” or “melt-spun” generally refers to fiber forming processes of spunbonding or melt-blowing.

The term “spunbond”, as used herein, may comprise fibers which are formed by extruding molten thermoplastic material as fibers from a plurality of fine, usually circular, capillaries of a spinneret with the diameter of the extruded fibers then being rapidly reduced. According to an embodiment of the invention, spunbond fibers are generally not tacky when they are deposited onto a collecting surface and may be generally continuous as disclosed and described herein. It is noted that the spunbond used in certain composites of the invention may include a nonwoven described in the literature as SPINLACE®. Spunbond fibers, for example, comprise continuous fibers.

As used herein, the term “continuous fibers” refers to fibers which are not cut from their original length prior to being formed into a nonwoven web or nonwoven fabric. Continuous fibers may have average lengths ranging from greater than about 15 centimeters to more than one meter, and up to the length of the web or fabric being formed. For example, a continuous fiber, as used herein, may comprise a fiber in which the length of the fiber is at least 1,000 times larger than the average diameter of the fiber, such as the length of the fiber being at least about 5,000, 10,000, 50,000, or 100,000 times larger than the average diameter of the fiber.

The term “machine direction” or “MD”, as used herein, comprises the direction in which the fabric produced or conveyed. The term “cross-direction” or “CD”, as used herein, comprises the direction of the fabric substantially perpendicular to the MD.

Certain embodiments according to the invention provide a process for forming a nonwoven fabric including a step of depositing at least a first nonwoven layer comprising a first plurality of interlaid individual meltspun fibers directly or indirectly onto a moving collection belt to provide a precursor nonwoven web having an average initial cross-direction (CD) width and/or an average initial basis weight. The first plurality of interlaid individual meltspun fibers may comprise (a) a combination of a first group of monocomponent fibers having a first onset of melting temperature and a second group of monocomponent fibers having a second onset of melting temperature that is lower than the first onset of melting temperature, (b) bicomponent fibers including a first component having a first onset of melting temperature and a second component having a second onset of melting temperature that is lower than the first onset of melting temperature, (c) a combination of a first group of bicomponent fibers having a first higher melting point component and a first lower melting point component, and a second group of bicomponent fibers having a second higher melting point component and a second lower melting point component that begins melting prior to the first lower melting point component; or (d) any combination of (a)-(c). The process may also comprise conveying the precursor nonwoven web through a heat-setting operation (HSO) comprising (a) restraining the precursor nonwoven web directly or indirectly within a heat-setting nip defined between the moving collection belt and a portion of a counter surface, such as a portion of a heat-setting apparatus, to mitigate relative movement of individual meltspun fibers during the HSO, and (b) subjecting the precursor nonwoven web to an elevated temperature sufficient to increase a tackiness of the second group of monocomponent fibers and/or the second component of bicomponent fibers having the second onset of melting temperature to provide an intermediate nonwoven fabric and/or the second lower melting point component of the second group of bicomponent fibers. The process may also comprise removing the intermediate nonwoven fabric from the HSO, wherein the intermediate nonwoven fabric has an average post-heat-setting CD width and/or an average post-heat-setting basis weight, and consolidating the intermediate nonwoven fabric to provide that nonwoven fabric having an average final CD width and/or an average final basis weight. In accordance with certain embodiments of the invention, the HSO may lightly bond or consolidate a portion of the meltspun fiber together to provide sufficient integrity for handling while the consolidation step more thoroughly bonds the meltspun fibers together to provide a significantly more durable and strong final nonwoven fabric relative to the intermediate nonwoven fabric formed after the HSO.

FIGS. 1-4 each illustrates a schematic of respective general processes in accordance with certain embodiments of the invention. Although FIG. 1-4 illustrate two meltpsinning beams, this if for illustration purposes only as anywhere from, for example, 1 to 10 individual beams may be used. The processes each include a HSO and consolidation or bonding unit located downstream from the HSO. These separate units may utilize any hot fluid in the process (e.g., hot air or steam) for achieving varying degrees of melt flows from the lower melt fibers (or fiber components) to flow and attach to the higher melt fibers (or fiber components) for varying degrees of bonding. For example, the HSO step is configured to achieve heat induced annealing, having temperatures above the glass transition temperature of the higher polymer for limited time during which the nonwoven web is constrained from physical movement, in which the elevated temperature is also above the softening or melting point (e.g., onset of melting temperature) of the lower melt polymer enabling pre-bonding. Additionally, the “HSO” step may contain a section for cooling the nonwoven prior to physical constraint being released and removed from the HSO. In accordance with certain embodiments of the invention, the cooling step may be particularly helpful to complete the heat setting process for the high temperature polymer (e.g., higher onset of melting temperature associated with one group of monocomponent fiber, bicomponent fibers, etc.), and to ensure web integrity for further transport to final bonding.

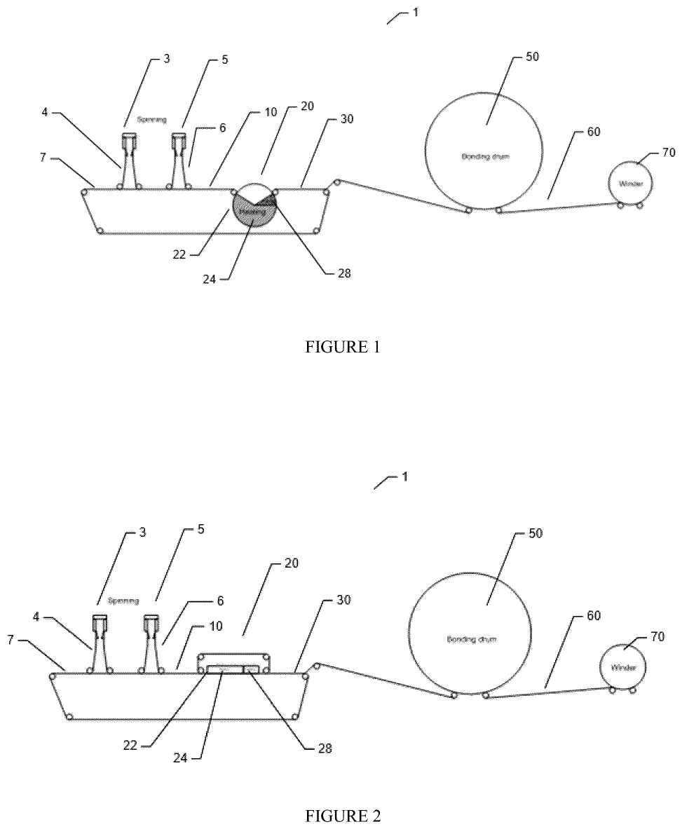

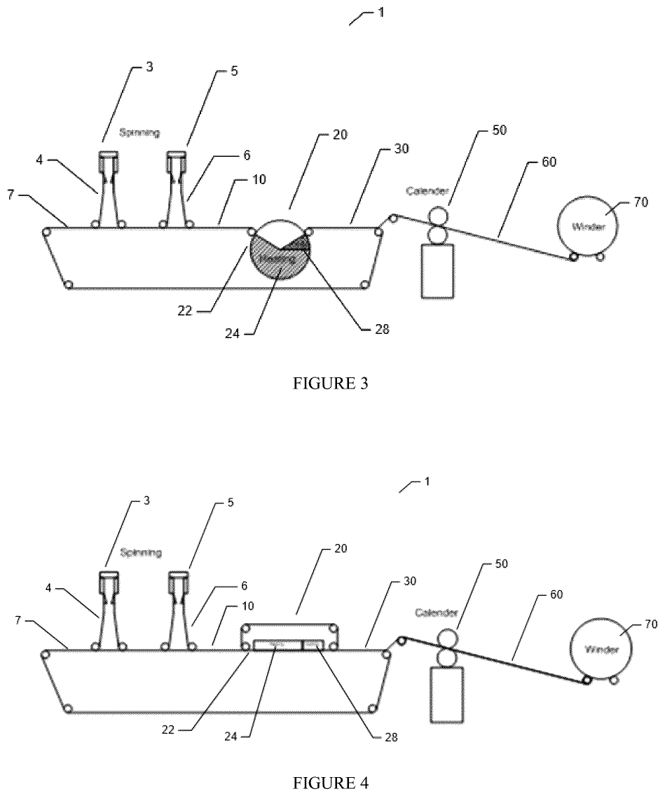

FIG. 1, for instance, illustrates a process 1 including two spunbond beams 3,5 that deposit continuous meltspun fibers 4,6 onto a moving collection belt 7 to form an unconsolidated nonwoven web 10, which is conveyed into and through a HSO 20. The nonwoven web 10 is physically restrained by the heat-setting nip 22 defined between the moving collection belt 7 and a portion of the HSO 20 and remains substantially constant tension or physical constraint on the nonwoven web until exiting the HSO to provide an intermediate nonwoven fabric 30. The HSO of FIG. 1 comprises a porous through-fluid-drum, which may rotate or remain stationary, having a heating portion 24 and a cooling portion 28. The intermediate nonwoven fabric 30 may then be conveyed to a bonding unit 50, which may be a bonding drum as illustrated in FIG. 1, for consolidation to provide a final nonwoven fabric 60. Optionally, the final nonwoven fabric may be collected on a winding roll 70. FIG. 2 illustrates another process 1 that is essentially the same as FIG. 1, but the HSO 20 includes a hot air knives instead of the porous drum of FIG. 1. FIGS. 3 and 4 are essentially the same as FIGS. 1 and 2, respectively, but replace the bonding unit 50 with a thermal calendering operation.

In accordance with certain embodiments of the invention, the elevated temperature associated with the HSO may be within about 7° C. below the second onset of melting temperature or the second lower melting point component of the second group of bicomponent fibers, such as within about any of the following: 6° C., 5° C., 4° C., 3° C., and 2° C. below the second onset of melting temperature second lower melting point component of the second group of bicomponent fibers. Additionally or alternatively, subjecting the precursor nonwoven web to the elevated temperature comprises a residence time from about 3 seconds to about 120 seconds, such as at least about any of the following: 3, 5, 8, 10, 15, 20, 30, 40, 50, and 60 seconds, and/or at most about any of the following: 120, 100, 90, 80, 70, and 60 seconds. Additionally or alternatively, the HSO may further comprise a cooling step that reduces the temperature of the precursor nonwoven web to about 20° C. to about 40° C. prior to exiting the heat-setting nip, such as at least about any of the following: 20, 22, 25, 28, and 30° C., and/or at most about any of the following: 40, 38, 35, 32, and 30° C.

In accordance with certain embodiments of the invention, the HSO comprises a porous rotating or stationary drum, wherein the heat-setting nip is defined by the drum and the moving collection belt. For example, the heat-setting nip defines a travelling path of the precursor nonwoven web extending around about 180° to about 340°, such as at least about any of the following: 180, 190, 200, 210, 220, 230, 240, 250, 260, and 270°, and/or at most about any of the following: 340, 330, 320, 310, 300, 290, 280, and 270°. Additionally or alternatively, the drum (e.g., stationary or rotating) also includes a cooling portion, in which the precursor nonwoven web is conveyed past the heating portion prior to being conveyed past the cooling portion. In this regard, the heating portion comprises from about 70 to about 95% of the travelling path, such as at least about any of the following: 70, 75, 80, and 85%, and/or at most about any of the following: 95, 90, and 85%, and the cooling portion comprises from about 5 to about 30% of the travelling path, such as at least about any of the following: 5, 10, and 15%, and/or at most about any of the following: 30, 25, 20, and 15%. In accordance with certain embodiments of the invention, the heating portion comprises discharging heated air outwardly therefrom and onto a corresponding section of the travelling path, or a thermally heating calendar.

In accordance with certain embodiments of the invention, the HSO comprise a linear through-air-bonding unit including a heating portion and a cooling portion, wherein the heat-setting nip defines a travelling path of the precursor nonwoven web between the linear through-air-bonding unit and the moving collection belt, and wherein the precursor nonwoven web is conveyed past the heating portion prior to being conveyed past the cooling portion. For example, the heating portion comprises from about 70 to about 95% of the travelling path, such as at least about any of the following: 70, 75, 80, and 85%, and/or at most about any of the following: 95, 90, and 85%, and the cooling portion comprises from about 5 to about 30% of the travelling path, such as at least about any of the following: 5, 10, and 15%, and/or at most about any of the following: 30, 25, 20, and 15%.

In accordance with certain embodiments of the invention, consolidating the intermediate nonwoven fabric may comprise a variety of consolidation means, such as a thermal calendering operation, a through-air-bonding operation, an ultrasonic bonding operation, a thermal area bonded operation, a chemical bonding operation, or any combination thereof, in which the first plurality of interlaid individual meltspun may optionally be subjected to an elevated temperature equal to or greater than the second onset of melting temperature or melting point associated with the second higher melting point component of the second group of bicomponent fibers, and optionally wherein the elevated temperature is below the second onset of melting temperature or melting point associated with the higher melting point component of the first group of bicomponent fibers. For example, the higher melting point fibers or fiber components may remain in a substantially non-deformed shape in accordance with certain embodiments of the invention.

The step of consolidating the intermediate nonwoven fabric may comprise a thermal calendering operation that imparts a plurality of discrete bond sites defining a bond area, wherein the bond area may comprise from about 3 to about 30%, such as at least about any of the following: 3, 5, 6, 8, 10, 12, 15, 18, and 20%, and/or at most about any of the following: 30, 28, 26, 25, 24, 22, and 20%. Alternatively, consolidating the intermediate nonwoven fabric may comprise a thermal area boned operation wherein at least a first outermost surface is completely bonded to define a continuous bond defining a microporous film structure.

In accordance with certain embodiments of the invention, the average post-heat-setting CD width is at least about 95% of the average initial CD width, such as at least about any of the following: 95, 96, 97, 98, 99, and 99.5% of the average initial CD width, and/or at most about any of the following: 100, 99.9, 99.8, 99.7, 99.6, and 99.5% of the average initial CD width. Additionally or alternatively, the average post-heat-setting basis weight is at least about 95% of the average initial basis weight, such as at least about any of the following: 95, 96, 97, 98, 99, and 99.5% of the average initial basis weight, and/or at most about any of the following: 100, 99.9, 99.8, 99.7, 99.6, and 99.5% of the average initial basis weight. Additionally or alternatively, the average final CD width is at least about 95% of the average post-heat-setting CD width, such as at least about any of the following: 95, 96, 97, 98, 99, and 99.5% of the average post-heat-setting CD width, and/or at most about any of the following: 100, 99.9, 99.8, 99.7, 99.6, and 99.5% of the average post-heat-setting CD width. Additionally or alternatively, the average final basis weight is at least about 95% of the average post-heat-setting basis weight, such as at least about any of the following: 95, 96, 97, 98, 99, and 99.5% of the average post-heat-setting basis weight, and/or at most about any of the following: 100, 99.9, 99.8, 99.7, 99.6, and 99.5% of the average post-heat-setting basis weight. Additionally or alternatively, the average final CD width is at least about 95% of the average initial CD width, such as at least about any of the following: 95, 96, 97, 98, 99, and 99.5% of the initial CD width, and/or at most about any of the following: 100, 99.9, 99.8, 99.7, 99.6, and 99.5% of the average initial CD width. Additionally or alternatively, the average final basis weight is at least about 95% of the average initial basis weight, such as at least about any of the following: 95, 96, 97, 98, 99, and 99.5% of the average initial basis weight, and/or at most about any of the following: 100, 99.9, 99.8, 99.7, 99.6, and 99.5% of the average initial basis weight.

In accordance with certain embodiments of the invention, the nonwoven web or nonwoven fabric may include the first plurality of individual meltspun fibers comprising the combination of the first group of monocomponent fibers or the first group of bicomponent fibers having the first onset of melting temperature and the second group of monocomponent fibers or the first group of bicomponent fibers having the second onset of melting temperature that is lower than the first onset of melting temperature, and wherein the first group of monocomponent fibers or the first group of bicomponent fibers define at least one first region, and the second group of monocomponent fibers or the first group of bicomponent fibers define at least one second region, and wherein first plurality of individual meltspun fibers are formed from a single polymeric composition.

In accordance with certain embodiments of the invention, the first group of monocomponent fibers or the first higher melting point component of the first group of bicomponent fibers has a first melting point range, and the second group of monocomponent fibers or the second lower melting point component of the second group of bicomponent fibers has a second melting point range; wherein the first melting point range and the second melting point range do not overlap. For example, a difference between closest values of the first melting point range and the second melting point range may be from 2 to 60° C., such as at least about any of the following: 2, 3, 4, 5, 6, 7, 8, 9, 10, 12, 15, 18. and 20° C., and/or at most about any of the following: 60, 50, 40, 30, 28, 25, 22, and 20° C. Additionally or alternatively, the second group of monocomponent fibers or the second lower melting point component of the second group of bicomponent fibers is deformed from an initially spun cross-section and fused with the first group of monocomponent fibers or the second group of bicomponent fibers during consolidating the intermediate nonwoven fabric.

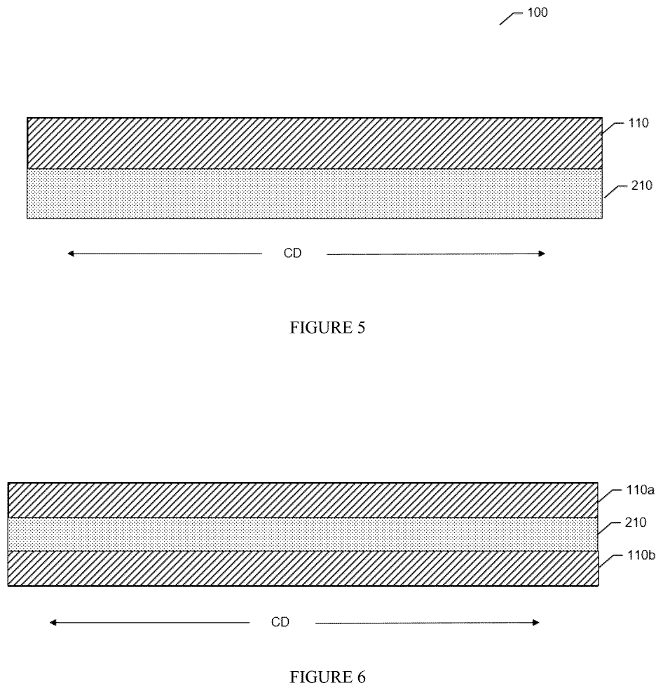

In accordance with certain embodiments of the invention, the nonwoven fabric 100, as illustrated by FIG. 5, may include a first group of monocomponent fibers or the first group of bicomponent fibers define at least a first higher melting point region 110 and a second group of monocomponent fibers or the second group of bicomponent fibers define at least a lower melting point region 210. FIG. 6, for instance, illustrates a nonwoven fabric 100 including a first group of meltspun fibers (e.g., first group of monocomponent meltspun fibers and/or a first group of bicomponent fibers) defining two high melting point regions 110a 110b and a second group of meltspun fibers (e.g., second group of monocomponent meltspun fibers and/or a second group of bicomponent fibers) defining a low melting point region 210 in accordance with certain embodiments of the invention. In this regard, the first group of monocomponent fibers or the first group of bicomponent fibers may define two separate higher melting point regions including, for example, a first outermost surface and/or a second outermost surface of the nonwoven fabric. In FIG. 6, the second group of monocomponent fibers or the second group of bicomponent fibers define at least a first lower melting point region 210 located adjacent to the first higher melting point region, the second higher melting point region, or both.

The resulting nonwoven fabric may have a total basis weight from about 10 grams-per-meter-squared (gsm) to about 200 gsm, such as at least about any of the following: 10, 12, 15, 18, 20, 22, 25, 28, 30, 32, 35, 38, 40, 45, and 50 gsm, and/or at most about any of the following: 200, 180, 150, 120, 100, 80, 70, 60, and 50 gsm. Additionally or alternatively, the first group of monocomponent fibers or the first group of bicomponent fibers comprises from about 50 to about 90% by weight of the total basis weight, such as at least about any of the following: 50, 55, 60, 65, and 70% by weight of the total basis weight, and/or at most about any of the following: 90, 85, 80, 75, and 70% by weight of the total basis weight. Additionally or alternatively, the second group of monocomponent fibers or the second group of bicomponent fibers comprises from about 10 to about 50% by weight of the total basis weight, such as at least about any of the following: 10, 15, 20, 25, and 30% by weight of the total basis weight, and/or at most about any of the following: 50, 45, 40, 35, and 30% by weight of the total basis weight.

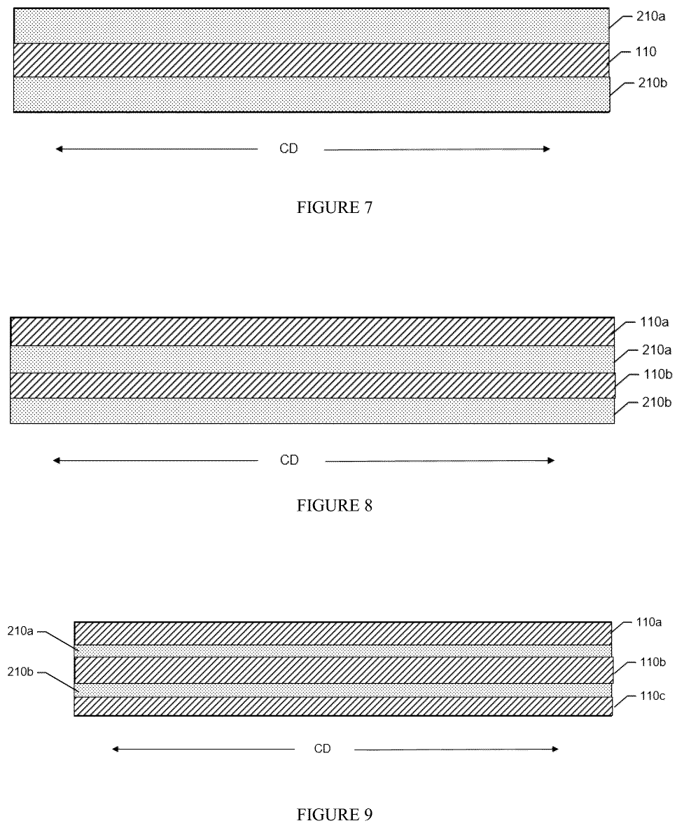

In accordance with certain embodiments of the invention, the second group of monocomponent fibers or the second group of bicomponent fibers may define at least first lower melting point region including a first outermost surface of the nonwoven fabric. Additionally or alternatively, the second group of monocomponent fibers or the second group of bicomponent fibers further defines a second lower melting point region including a second outermost surface of the nonwoven fabric. Additionally or alternatively, the first group of monocomponent fibers or the first group of bicomponent fibers define at least a higher melting point region located adjacent to the first lower melting point region, the second lower melting point region, or both. FIG. 7, for instance, illustrates such a resulting nonwoven fabric. FIG. 7 illustrates a nonwoven fabric 100 including a first group of meltspun fibers (e.g., first group of monocomponent meltspun fibers and/or a first group of bicomponent fibers) defining an interior high melting point region 110 and a second group of meltspun fibers (e.g., second group of monocomponent meltspun fibers and/or a second group of bicomponent fibers) defining two low melting point regions 210a, 210b in accordance with certain embodiments of the invention. Additionally or alternatively, the nonwoven fabric may have a total basis weight from about 10 grams-per-meter-squared (gsm) to about 200 gsm, such as at least about any of the following: 10, 12, 15, 18, 20, 22, 25, 28, 30, 32, 35, 38, 40, 45, and 50 gsm, and/or at most about any of the following: 200, 180, 150, 120, 100, 80, 70, 60, and 50 gsm. Additionally or alternatively, the first group of monocomponent fibers or the first group of bicomponent fibers comprises from about 50 to about 90% by weight of the total basis weight, such as at least about any of the following: 50, 55, 60, 65, and 70% by weight of the total basis weight, and/or at most about any of the following: 90, 85, 80, 75, and 70% by weight of the total basis weight. Additionally or alternatively, the second group of monocomponent fibers or the second group of bicomponent fibers comprises from about 10 to about 50% by weight of the total basis weight, such as at least about any of the following: 10, 15, 20, 25, and 30% by weight of the total basis weight, and/or at most about any of the following: 50, 45, 40, 35, and 30% by weight of the total basis weight.

In accordance with certain embodiments of the invention, the first group of monocomponent fibers or the first group of bicomponent fibers may define a plurality of first higher melting point regions, and the second group of monocomponent fibers or the second group of bicomponent fibers define a plurality of first lower melting point regions. For example, the plurality of first higher melting point regions and the plurality of first lower melting point regions may be located in an alternating pattern along a machine-direction of the nonwoven fabric, a z-direction that is perpendicular to the machine-direction and the cross-direction, or both. Alternatively, the plurality of first higher melting point regions and the plurality of first lower melting point regions are located in an alternating pattern along a cross-direction of the nonwoven fabric, a z-direction that is perpendicular to the cross-direction and a machine-direction, or both. In accordance with certain embodiments of the invention, the plurality of first higher melting point regions and the plurality of first lower melting point regions are located in an alternating pattern along a cross-direction and a machine-direction. In accordance with certain embodiments of the invention, the plurality of first higher melting point regions and the plurality of first lower melting point regions are also located in an alternating pattern in a z-direction of the nonwoven fabric, wherein the z-direction is perpendicular to the cross-direction and the machine-direction. Additionally or alternatively, the nonwoven fabric may have a total basis weight from about 10 grams-per-meter-squared (gsm) to about 200 gsm, such as at least about any of the following: 10, 12, 15, 18, 20, 22, 25, 28, 30, 32, 35, 38, 40, 45, and 50 gsm, and/or at most about any of the following: 200, 180, 150, 120, 100, 80, 70, 60, and 50 gsm. Additionally or alternatively, the first group of monocomponent fibers or the first group of bicomponent fibers comprises from about 50 to about 90% by weight of the total basis weight, such as at least about any of the following: 50, 55, 60, 65, and 70% by weight of the total basis weight, and/or at most about any of the following: 90, 85, 80, 75, and 70% by weight of the total basis weight. Additionally or alternatively, the second group of monocomponent fibers or the second group of bicomponent fibers comprises from about 10 to about 50% by weight of the total basis weight, such as at least about any of the following: 10, 15, 20, 25, and 30% by weight of the total basis weight, and/or at most about any of the following: 50, 45, 40, 35, and 30% by weight of the total basis weight.

FIG. 8, for instance, illustrates a nonwoven fabric 100 including a first group of meltspun fibers (e.g., first group of monocomponent meltspun fibers and/or a first group of bicomponent fibers) defining a plurality of high melting point regions 110a, 110b and a second group of meltspun fibers (e.g., second group of monocomponent meltspun fibers and/or a second group of bicomponent fibers) defining a plurality of low melting point regions 210a, 210b, in which the high melting point regions and the low melting point regions are located in alternating fashion in a z-direction, in accordance with certain embodiments of the invention.

FIG. 9, for instance, illustrates another nonwoven fabric 100 including a first group of meltspun fibers (e.g., first group of monocomponent meltspun fibers and/or a first group of bicomponent fibers) defining a plurality of high melting point regions 100a-100c, and a second group of meltspun fibers (e.g., second group of monocomponent meltspun fibers and/or a second group of bicomponent fibers) defining a plurality of low melting point regions 210a, 210b, in which the high melting point regions and the low melting point regions are located in alternating fashion in a z-direction, in accordance with certain embodiments of the invention.

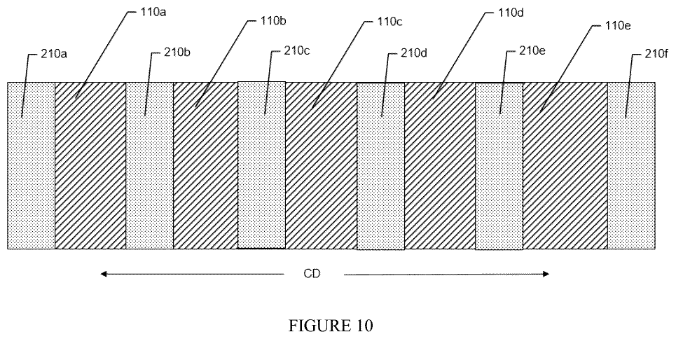

FIG. 10, for instance, illustrates a nonwoven fabric 100 including a first group of meltspun fibers (e.g., first group of monocomponent meltspun fibers and/or a first group of bicomponent fibers) defining a plurality of high melting point regions 110a-110e, and a second group of meltspun fibers (e.g., second group of monocomponent meltspun fibers and/or a second group of bicomponent fibers) defining a plurality of low melting point regions 210a-210f, in which the high melting point regions and the low melting point regions are located in alternating fashion in the cross-direction, in accordance with certain embodiments of the invention;

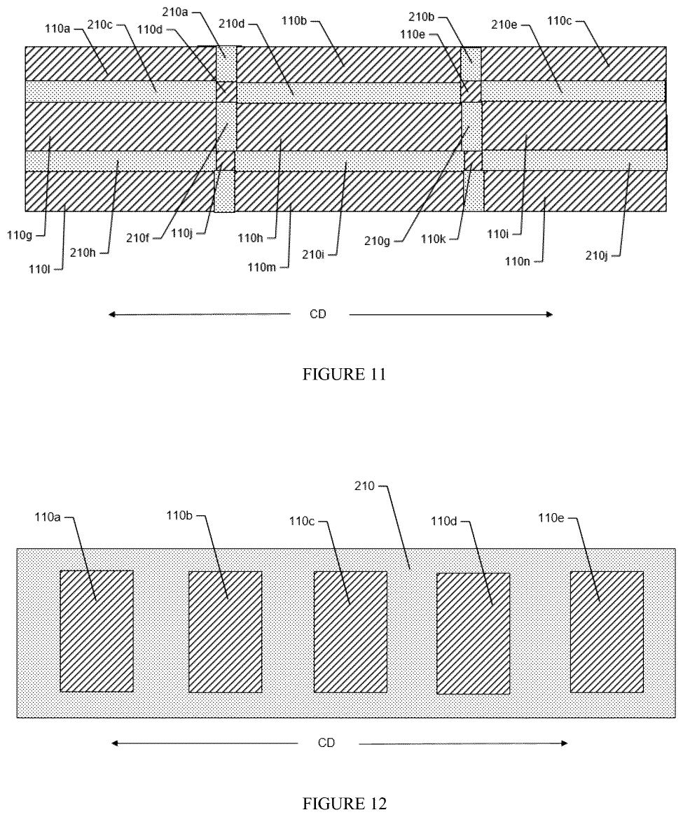

FIG. 11, for instance, illustrates a nonwoven fabric 100 including a first group of meltspun fibers (e.g., first group of monocomponent meltspun fibers and/or a first group of bicomponent fibers) defining a plurality of high melting point regions 110a-110n, and a second group of meltspun fibers (e.g., second group of monocomponent meltspun fibers and/or a second group of bicomponent fibers) defining a plurality of low melting point regions 210a-2101, in which the high melting point regions and the low melting point regions are located in alternating fashion in both the z-direction and the cross-direction, in accordance with certain embodiments of the invention.

In accordance with certain embodiments of the invention, the first group of monocomponent fibers or the first group of bicomponent fibers may define a higher melting point region comprising a continuous region, and the second group of monocomponent fibers or the second group of bicomponent fibers define a plurality of lower melting point regions comprising separate islands dispersed throughout the continuous region. Alternatively, the second group of monocomponent fibers or the second group of bicomponent fibers may define a lower melting point region comprising a continuous region, and the first group of monocomponent fibers define or the first group of bicomponent fibers a plurality of higher melting point regions comprising separate islands dispersed throughout the continuous region. In accordance with certain embodiments of the invention, the nonwoven fabric has a total basis weight from about 10 grams-per-meter-squared (gsm) to about 200 gsm, such as at least about any of the following: 10, 12, 15, 18, 20, 22, 25, 28, 30, 32, 35, 38, 40, 45, and 50 gsm, and/or at most about any of the following: 200, 180, 150, 120, 100, 80, 70, 60, and 50 gsm. Additionally or alternatively, the first group of monocomponent fibers or the first group of bicomponent fibers comprises from about 50 to about 90% by weight of the total basis weight, such as at least about any of the following: 50, 55, 60, 65, and 70% by weight of the total basis weight, and/or at most about any of the following: 90, 85, 80, 75, and 70% by weight of the total basis weight. Additionally or alternatively, the second group of monocomponent fibers or the second group of bicomponent fibers comprises from about 10 to about 50% by weight of the total basis weight, such as at least about any of the following: 10, 15, 20, 25, and 30% by weight of the total basis weight, and/or at most about any of the following: 50, 45, 40, 35, and 30% by weight of the total basis weight.

FIG. 12, for instance, illustrates a nonwoven fabric 100 having a second group of meltspun fibers (e.g., second group of monocomponent meltspun fibers and/or a second group of bicomponent fibers) defining continuous low melting point region 210 and a first group of meltspun fibers (e.g., first group of monocomponent meltspun fibers and/or a first group of bicomponent fibers) defining a plurality of high melting point regions 110a-110e dispersed throughout the low melting point region in accordance with certain embodiments of the invention.

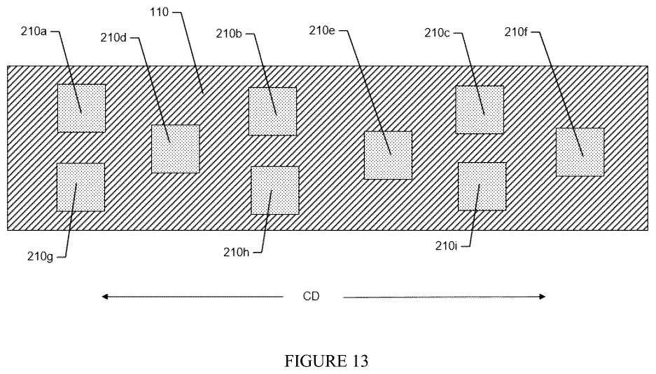

FIG. 13, for instance, illustrates a nonwoven fabric 100 having a first group of meltspun fibers (e.g., first group of monocomponent meltspun fibers and/or a first group of bicomponent fibers) defining continuous high melting point region 110 and a second group of meltspun fibers (e.g., second group of monocomponent meltspun fibers and/or a second group of bicomponent fibers) defining a plurality of low melting point regions 210a-210i dispersed throughout the high melting point region in accordance with certain embodiments of the invention;

In accordance with certain embodiments of the invention, the first group of monocomponent fibers or the first group of bicomponent fibers comprise a round outermost cross-section, a non-round outermost cross-section, or both. For example, the first group of monocomponent fibers or the first group of bicomponent fibers comprise an average diameter from about 8 to about 40 microns, such as at least about any of the following: 8, 10, 12, 15, 18, and 10 microns, and/or at most about any of the following: 40, 28, 35, 32, 30, 28, 25, 22, and 20 microns. Additionally or alternatively, the first group of monocomponent fibers or the first group of bicomponent fibers may comprise a round outermost cross-section having an aspect ratio from 0.8 to 1.2, such as about 0.8, 0.9, and 1, and/or at most about 1.2, 1.1, and 1.

In accordance with certain embodiments of the invention, the first group of monocomponent fibers or the first group of bicomponent fibers may comprise a non-round outermost cross-section having an aspect ratio of at least 1.5, such as at least about any of the following: 1.5, 2, 3, 4, and 5, and/or at most about any of the following: 10, 9, 8, 7, 6, and 5.

In accordance with certain embodiments of the invention, the first group of monocomponent fibers or the first group of bicomponent fibers comprise a combination of round outermost cross-section fibers and non-round outermost cross-section fibers. For example, the round outermost cross-section fibers comprise from 1 to about 99% of a total number of the first group of monocomponent fibers or the first group of bicomponent fibers, such as at least about any of the following: 1, 3, 5, 10, 15, 20, 25, 30, 35, 40, 45, and 50% of a total number of the first group of monocomponent fibers or the first group of bicomponent fibers, and/or at most about any of the following: 99, 98, 95, 90, 85, 80, 75, 70, 65, 60, 55, and 50% of a total number of the first group of monocomponent fibers or the first group of bicomponent fibers. Additionally or alternatively, the non-round outermost cross-section fibers comprise from 1 to about 99% of a total number of the first group of monocomponent fibers or the first group of bicomponent fibers, such as at least about any of the following: 1, 3, 5, 10, 15, 20, 25, 30, 35, 40, 45, and 50% of a total number of the first group of monocomponent fibers or the first group of bicomponent fibers, and/or at most about any of the following: 99, 98, 95, 90, 85, 80, 75, 70, 65, 60, 55, and 50% of a total number of the first group of monocomponent fibers or the first group of bicomponent fibers.

In accordance with certain embodiments of the invention, the second group of monocomponent fibers or the second group of bicomponent fibers comprise a round outermost cross-section, a non-round outermost cross-section, or both. Additionally or alternatively, the second group of monocomponent fibers or the second group of bicomponent fibers comprise an average diameter from about 8 to about 40 microns, such as at least about any of the following: 8, 10, 12, 15, 18, and 10 microns, and/or at most about any of the following: 40, 28, 35, 32, 30, 28, 25, 22, and 20 microns. Additionally or alternatively, the second group of monocomponent fibers or the second group of bicomponent fibers comprise a round outermost cross-section having an aspect ratio from 0.8 to 1.2, such as about 0.8, 0.9, and 1, and/or at most about 1.2, 1.1, and 1.

In accordance with certain embodiments of the invention, the second group of monocomponent fibers or the second group of bicomponent fibers comprise a non-round outermost cross-section having an aspect ratio of at least 1.5, such as at least about any of the following: 1.5, 2, 3, 4, and 5, and/or at most about any of the following: 10, 9, 8, 7, 6, and 5.

In accordance with certain embodiments of the invention, the second group of monocomponent fibers or the second group of bicomponent fibers comprise a combination of round outermost cross-section fibers and non-round outermost cross-section fibers. For example, the round outermost cross-section fibers comprise from 1 to about 99% of a total number of the second group of monocomponent fibers or the second group of bicomponent fibers, such as at least about any of the following: 1, 3, 5, 10, 15, 20, 25, 30, 35, 40, 45, and 50% of a total number of the second group of monocomponent fibers or the second group of bicomponent fibers, and/or at most about any of the following: 99, 98, 95, 90, 85, 80, 75, 70, 65, 60, 55, and 50% of a total number of the second group of monocomponent fibers or the second group of bicomponent fibers. Additionally or alternatively, the non-round outermost cross-section fibers comprise from 1 to about 99% of a total number of the second group of monocomponent fibers or the second group of bicomponent fibers, such as at least about any of the following: 1, 3, 5, 10, 15, 20, 25, 30, 35, 40, 45, and 50% of a total number of the second group of monocomponent fibers or the second group of bicomponent fibers, and/or at most about any of the following: 99, 98, 95, 90, 85, 80, 75, 70, 65, 60, 55, and 50% of a total number of the second group of monocomponent fibers or the second group of bicomponent fibers.

In accordance with certain embodiments of the invention, the first group of monocomponent fibers and the second group of monocomponent fibers may comprise the single polymeric composition, wherein the single polymeric composition comprises a polymer component comprising a polyolefin or copolymer thereof, a polyester or copolymer thereof, a polyamide or a copolymer thereof, or a biopolymer, such as polylactic acid; or wherein the first higher melting point component and a first lower melting point component of the first group of bicomponent fibers independently from each other comprise a polymer component comprising a polyolefin or copolymer thereof, a polyester or copolymer thereof, a polyamide or a copolymer thereof, or a biopolymer, such as polylactic acid; or wherein the second higher melting point component and the second lower melting point component of the second group of bicomponent fibers independently from each other comprise a polymer component comprising a polyolefin or copolymer thereof, a polyester or copolymer thereof, a polyamide or a copolymer thereof, or a biopolymer, such as polylactic acid. For example, the polyolefin may comprises a polypropylene a copolymer thereof, a polyethylene a copolymer thereof, or blends thereof.

As noted above, the resulting nonwoven fabric may comprises a through-air-bonded nonwoven fabric, an area bonded nonwoven fabric, or a thermally calendered nonwoven fabric having a plurality of discrete bond sites. In accordance with certain embodiments of the invention, the second group of monocomponent fibers or the second group of bicomponent fibers have a deformed cross-section from at least partially melting, flowing, and bonding to the first group of monocomponent fibers or the first group of bicomponent fibers. In accordance with certain embodiments of the invention, the first group of monocomponent fibers have a non-deformed cross-section.

In accordance with certain embodiments of the invention, the first plurality of interlaid individual meltspun fibers comprise meltspun fibers, spunbond fibers, or both. Additionally or alternatively, the process may comprise depositing one or more additional nonwoven layers, such as 1, 2, 3, 4, 5, 6, 7, 8, 9, or 10 additional layers, of meltspun fibers directly or indirectly onto the first nonwoven layer. Additionally or alternatively, the one or more additional nonwoven layers independently from each other comprise (a), (b), or (c) as set forth above.

In another aspect, the present invention provides a heat-set nonwoven fabric including at least a first plurality of interlaid individual meltspun fibers comprising (a) a combination of a first group of monocomponent fibers having a first onset of melting temperature and a second group of monocomponent fibers having a second onset of melting temperature that is lower than the first onset of melting temperature, (b) bicomponent fibers including a first component having a first onset of melting temperature and a second component having a second onset of melting temperature that is lower than the first onset of melting temperature, (c) a combination of a first group of bicomponent fibers having a first higher melting point component and a first lower melting point component, and a second group of bicomponent fibers having a second higher melting point component and a second lower melting point component that begins melting prior to the first lower melting point component; or (d) any combination of (a)-(c). The nonwoven fabric may be a through-air-bonded nonwoven fabric, chemically bonded nonwoven fabric, mechanically consolidated nonwoven fabric, and/or a thermally bonded nonwoven fabric. In this regard, nonwoven webs (e.g., spunbond webs) may be consolidated via a through-fluid-bonding (e.g., fluid includes hot air or steam) process in which, optionally, only the lower melting point fibers (or component) are softened, melted, and/or flowed throughout a portion of the nonwoven web to form bonds with the higher melting point fibers. In this regard, the structural integrity of the resulting nonwoven fabric, in accordance with certain embodiments of the invention, may be provided by the higher melting point fibers (or higher melting point fiber components) that may remain in a non-deformed or substantially non-deformed (e.g., the cross-section of the high melting point fibers or fiber components remain the same or substantially the same before, during, and after the consolidation operation). To the contrary, the lower melting point fibers (or fiber components) may have a deformed cross-section or individually undiscernible as individual fibers due to melting and/or flowing to provide the bonding mechanism for consolidation. For example, the lower melting point fibers (or fiber components) may at least partially melt and flow through at least some of the gaps defined between the higher melting point fibers. As the lower point melting fibers (or fiber components) flow through gaps between the higher melting point fibers, the deforming and flowing lower melting point fibers (e.g., less crystalline or amorphous) coat the surfaces of the higher melting point fibers (or fiber components). Upon solidification of the lower melting point material (e.g., the melted and flowed lower melting point fibers) after coating the surfaces of the higher melting point fibers (or fiber components), the lower melting point material forms bonds to and between the higher melting point material (e.g., the deformed lower melting point fibers).

In another aspect, the present invention provides a method of forming a composite comprising forming or providing a nonwoven fabric, such as those described and disclosed herein, and bonding a film layer to the nonwoven fabric. In another aspect, the present invention provides a composite including a nonwoven fabric, such as those described and disclosed herein, and a film.

In accordance with certain embodiments of the invention, the film layer is a single layer film. For example, the single layer film is a vapor permeable, liquid impermeable (VPLI) film that it permeable to vapor but impermeable to liquid water. The VPLI film, for instance, may be a monolithic film or a microporous film.

In accordance with certain embodiments of the invention, the film layer may be a multi-layer film including a core layer and at least a first skin layer. The multi-layer film, for example, may include a second skin layer, wherein the core layer is located between and adjacent the first skin layer and the second skin layer. By way of example, the core layer may be a microporous layer or a monolithic layer. The first skin layer, the second skin layer, or both may comprise a microporous layer or a monolithic layer. Additionally or alternatively, the multi-layer film may be a vapor permeable, liquid impermeable (VPLI) film.

In accordance with certain embodiments of the invention, the film layer may have a basis weight from about 5 to about 50 gsm, such as at least about any of the following: 5, 10, 12, 15, 18, 20, 22, and 25 gsm, and/or at most about any of the following: 50, 45, 40, 35, 30, 28, and 25 gsm. Additionally or alternatively, the film layer is melt extruded directly onto the nonwoven fabric. Alternatively, the film layer is adhesively bonded to the nonwoven fabric via an adhesive layer.

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

What is claimed is:

1. A process for forming a nonwoven fabric, comprising:
(i) depositing at least a first nonwoven layer comprising a first plurality of interlaid individual meltspun fibers directly or indirectly onto a moving collection belt to provide a precursor nonwoven web having an average initial cross-direction (CD) width and/or an average initial basis weight,
wherein the first plurality of individual meltspun fibers comprise (a) a combination of a first group of monocomponent fibers having a first onset of melting temperature and a second group of monocomponent fibers having a second onset of melting temperature that is lower than the first onset of melting temperature, (b) bicomponent fibers including a first component having a first onset of melting temperature and a second component having a second onset of melting temperature that is lower than the first onset of melting temperature, or (c) a combination of a first group of bicomponent fibers having a first higher melting point component and a first lower melting point component, and a second group of bicomponent fibers having a second higher melting point component and a second lower melting point component that begins melting prior to the first lower melting point component;
(ii) conveying the precursor nonwoven web through a heat-setting operation (HSO) comprising (a) restraining the precursor nonwoven web directly or indirectly within a heat-setting nip defined between the moving collection belt and a portion of a counter surface, such as a portion of a heat-setting apparatus, to mitigate relative movement of individual meltspun fibers during the HSO, and (b) subjecting the precursor nonwoven web to an elevated temperature sufficient to increase a tackiness of (1) the second group of monocomponent fibers or (2) the second component of bicomponent fibers having the second onset of melting temperature or (3) the second lower melting point component of the second group of bicomponent fibers to provide an intermediate nonwoven fabric;
(iii) removing the intermediate nonwoven fabric from the HSO, wherein the intermediate nonwoven fabric has an average post-heat-setting CD width and/or an average post-heat-setting basis weight; and
(iv) consolidating the intermediate nonwoven fabric to provide that nonwoven fabric having an average final CD width and/or an average final basis weight.

2. The process of claim 1, wherein (i) the elevated temperature is not within about 7° C. below the second onset of melting temperature or the second lower melting point component of the second group of bicomponent fibers, and/or (ii) subjecting the precursor nonwoven web to the elevated temperature comprises a residence time from about 3 seconds to about 120 seconds.

3. The process of claim 1, wherein the HSO further comprises a cooling step that reduces the temperature of the precursor nonwoven web to about 20° C. to about 40° C. prior to exiting the heat-setting nip.

4. The process of claim 1, wherein the HSO comprises a rotating drum, wherein the heat-setting nip is defined by the rotating drum and the moving collection belt.

5. The process of claim 4, wherein the heat-setting nip defines a travelling path of the precursor nonwoven web extending around about 180° to about 340° of the rotating drum.

6. The processes of claim 4, wherein the rotating drum comprises a heating portion and a cooling portion, wherein the precursor nonwoven web is conveyed past the heating portion prior to being conveyed past the cooling portion.

7. The process of claim 6, wherein the heating portion comprises from about 70 to about 95% of the travelling path.

8. The process of claim 1, wherein the HSO comprises a linear through-air-bonding unit including a heating portion and a cooling portion, wherein the heat-setting nip defines a travelling path of the precursor nonwoven web between the linear through-air-bonding unit and the moving collection belt, and wherein the precursor nonwoven web is conveyed past the heating portion prior to being conveyed past the cooling portion.

9. The process of claim 8, wherein the heating portion comprises from about 70 to about 95% of the travelling path.

10. The process of claim 1, wherein consolidating the intermediate nonwoven fabric comprises a thermal calendering operation, a through-air-bonding operation, an ultrasonic bonding operation, a thermal area bonded operation, a chemical bonding operation, or any combination thereof;
wherein the first plurality of interlaid individual meltspun are subjected to an elevated temperature equal to or greater than the second onset of melting temperature or melting point associated with the second higher melting point component of the second group of bicomponent fibers, and optionally wherein the elevated temperature is below the first onset of melting temperature or melting point associated with the first higher melting point component of the first group of bicomponent fibers.

11. The process of claim 10, wherein the consolidating the intermediate nonwoven fabric comprises a thermal calendering operation imparts a plurality of discrete bond sites defining a bond area, wherein the bond area may comprise from about 3 to about 30%.

12. The process of claim 1, wherein (i) the average post-heat-setting CD width is at least about 95% of the average initial CD width, and/or (ii) the average post-heat-setting basis weight is at least about 95% of the average initial basis weight.

13. The process of claim 1, wherein (i) the average final CD width is at least about 95% of the average post-heat-setting CD width, and/or (ii) the average final basis weight is at least about 95% of the average post-heat-setting basis weight.

14. The process of claim 1, wherein (i) the average final CD width is at least about 95% of the average initial CD width, and/or (ii) the average final basis weight is at least about 95% of the average initial basis weight.

15. The process of claim 1, wherein the first plurality of individual meltspun fibers include the combination of the first group of monocomponent fibers or the first group of bicomponent fibers having the first onset of melting temperature and the second group of monocomponent fibers or the first group of bicomponent fibers having the second onset of melting temperature that is lower than the first onset of melting temperature, and wherein the first group of monocomponent fibers or the first group of bicomponent fibers define at least one first region, and the second group of monocomponent fibers or the first group of bicomponent fibers define at least one second region, and wherein first plurality of individual meltspun fibers are formed from a single polymeric composition.

16. The process of claim 15, wherein the second group of monocomponent fibers or the second lower melting point component of the second group of bicomponent fibers is deformed from an initially spun cross-section and fused with the first group of monocomponent fibers or the second group of bicomponent fibers during consolidating the intermediate nonwoven fabric.

17. The process of claim 1, wherein the first plurality of interlaid individual meltspun fibers comprise meltspun fibers, spunbond fibers, or both.

18. A method of forming a composite, comprising:
(i) forming a nonwoven fabric according to claim 1; and
(ii) bonding a film layer to the nonwoven fabric.

19. The method of claim 18, wherein the film layer is a single layer film or a multi-layer film.

20. The method of claim 18, wherein the film layer is melt extruded directly onto the nonwoven fabric or adhesively bonded to the nonwoven fabric via an adhesive layer.
